(19) United States
(12) Patent Application Publication
(10) Pub. No.: US 2016/0278127 A1
(43) Pub. Date: Sep. 22, 2016

(54) A Network Node, a User Equipment and Methods Therein for Random Access

(71) Applicant: TELEFONAKTIEBOLAGET L M ERICSSON (PUBL), Stockholm (SE)

(72) Inventors: Kai-Erik SUNELL, Bromma (SE); Erik ERIKSSON, Linköping (SE); Emre YAVUZ, Stockholm (SE)

(21) Appl. No.: 14/402,017

(22) PCT Filed: Oct. 29, 2014
(86) PCT No.: PCT/SE2014/051277

§ 371 Date: Nov. 18, 2014

Related U.S. Application Data
(60) Provisional application No. 61/955,845, filed on Mar. 20, 2014.

(51) Int. Cl. H04W 74/08; H04W 4/00

(52) U.S. Cl. CPC H04W 74/0833; H04W 4/005

(57) ABSTRACT

A method in a network node for random access of a user equipment to the network node.

The network node receives (302) a random access request from the user equipment. The random access request comprises a preamble that belong to a preamble area, which preamble area comprises one or more preambles available for transmission of random access requests from the user equipment. The preamble area is defined by a first random access preamble and a last random access preamble. The preamble area is overlapping with any one or more out of: preambles used for contention free random access and preambles used for contention-based random access.

The network node transmits (303) to the user equipment a random access response. The random access response has a size based on the preamble that belongs to the preamble area.

### TECHNICAL FIELD

Embodiments herein relate to a network node, a user equipment and methods therein for random access. In particular they relate to random access to the network node.

### BACKGROUND

Communication devices such as terminals are also known as e.g. User Equipments (UE), mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Examples of wireless communication systems are Long Term Evolution (LTE), Universal Mobile Telecommunications System (UMTS) and Global System for Mobile communications (GSM).

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

3GPP has recently agreed within the scope of a low-cost Machine Type Communication (MTC) work item to introduce a new UE category termed as category 0. A UE category is a set of requirements and capabilities that a UE declaring this capability is obliged to fulfil. A draft Change Request (CR) for the introduction of category 0 is available in document R2-140964 as presented during RAN2#85 meeting in Prague, 10.02.2014 to 14.02.2014, Prague, Czech Republic.

UEs of this new category are less capable than e.g. UEs of legacy category 1, which currently is the least capable legacy category. A legacy category is herein defined as any previously specified category, i.e. category 1 to 10 according to 3GPP TS 36.306 version 11.8.0. For example, the category 0 UEs have limited memory and processing requirements, i.e. limited memory and processing capabilities, compared to UEs of legacy category 1.

A problem arises, since the category 0 UEs will co-exist in a wireless communications network together with legacy UEs and the base station or eNB does not know whether the UE has any limitations or not upon the transmission of a random access response message, e.g. Msg2 in LTE, to the UE. If the eNB sends legacy random access response message to a category 0 UE the category 0 UE will not be able to decode the message due to its limitation in memory and processing capability, and consequently the random access will fail.

### SUMMARY

It is therefore an object of embodiments herein to provide an improved way of random access of user equipments in a wireless communications network.

According to a first aspect of embodiments herein, the object is achieved by a method in a network node for random access of a user equipment to the network node in a wireless communications network.

The network node receives a random access request from the user equipment. The random access request comprises a preamble that belong to a preamble area. The preamble area comprises one or more preambles available for transmission of random access requests from the user equipment. The preamble area is defined by a first random access preamble and a last random access preamble. The preamble area is overlapping with any one or more out of: preambles used for contention free random access and preambles used for contention-based random access.

The network node transmits to the user equipment a random access response. The random access response has a size based on the preamble that belong to the preamble area.

According to a second aspect of embodiments herein, the object is achieved by a network node for random access of a user equipment to the network node in a wireless communications network.

The network node is configured to receive from the user equipment a random access request. The random access request comprises a preamble that belong to a preamble area. The preamble area comprises one or more preambles available for transmission of random access requests from the user equipment. The preamble area is defined by a first random access preamble and a last random access preamble. The preamble area is overlapping with any one or more out of: preambles used for contention free random access and preambles used for contention-based random access.

The network node is configured to transmit to the user equipment a random access response, which random access response has a size based on the preamble that belong to the preamble area.

According to a third aspect of embodiments herein, the object is achieved by a method in a user equipment for random access of the user equipment to a network node in a wireless communications network.

The user equipment obtains information on a preamble area comprising one or more preambles available for transmission of a random access request from the user equipment. The preamble area is defined by a first random access preamble and a last random access preamble. The preamble area is overlapping with any one or more out of: preambles used for contention free random access and preambles used for contention-based random access.

The user equipment selects a preamble from the preamble area.

The user equipment transmits a random access request to the network node. The random access request comprises the selected preamble that belong to the preamble area.

The user equipment receives a random access response, which random access response has a size based on the selected preamble that belong to the preamble area.

According to a fourth aspect of embodiments herein, the object is achieved by a user equipment for random access of the user equipment to a network node in a wireless communications network.

The user equipment is configured to obtain information on a preamble area comprising one or more preambles available for transmission of a random access request from the user equipment, which preamble area is defined by a first random access preamble and a last random access preamble, and which preamble area is overlapping with any one or more out of: preambles used for contention free random access and preambles used for contention-based random access,

The user equipment is configured to select a preamble from the preamble area.

The user equipment is configured to transmit a random access request to the network node. The random access request comprises the selected preamble that belong to the preamble area.

The user equipment is configured to receive a random access response, which random access response has a size based on the selected preamble that belong to the preamble area.

Since the size of the random access response is based on the preamble that belong to the preamble area the user equipment is able to decode the random access response.

An advantage with embodiments herein is that they enable the user equipment to use random access preambles in a flexible way while it is still possible for the network node to distinguish between different categories of user equipment. More specifically, the preamble area is reconfigurable for the different categories of user equipment, including category 0 or any other category that comprises user equipment with limited capabilities compared to the least capable legacy category, i.e. category 1. For example, it is possible to make use of legacy preamble grouping also for user equipment of category 0.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a combined signalling diagram and flowchart illustrating embodiments of a method in a wireless communications network.

FIG. 3 is a flowchart illustrating embodiments of a method in a network node.

FIG. 4 is a schematic block diagram illustrating embodiments of a network node.

FIG. 5 is a flowchart illustrating embodiments of a method in a user equipment.

FIG. 6 is a schematic block diagram illustrating embodiments of a user equipment.

### DETAILED DESCRIPTION

As part of developing embodiments herein, a problem will first be identified and discussed. LTE will be used as an example of a wireless communications network in which the problem may arise.

UEs of different categories have different limitations regarding how much information that they are able to receive at a time. For example category 0 UEs are able to receive much less information than UEs of the least capable legacy category, i.e. category 1. Since it is unacceptable to assume that all UEs have the same limitation, different techniques to distinguish between legacy UEs and category 0 UEs already from the random access message, or Msg1, has been discussed.

Before a UE makes a random access, it reads system information to acquire information on what kind of preambles are available for transmission of random access request on the Random Access Channel (RACH). Evolved Universal Terrestrial Radio Access (EUTRA) system information includes an information element called RACH-ConfigCommon that defines a sequence called preambleInfo for that purpose. The preambleInfo provides information about the number of available preambles as well as possible grouping of the preambles if grouping is used. The RACH-ConfigCommon information element may be found in 3GPP document TS 36.331 sub clause 6.3.2.

It has been discussed to modify and/or extend an existing preamble partitioning method to indicate support of category 0. A preamble partitioning method is a method for partition the available preambles in a cell.

The existing partitioning method may divide the preambles into preambles for contention-based and contention-free random access. The existing partitioning method may further divide the preambles into two groups A and B respectively. Group A preambles are intended for sending small packets and Group B preambles are intended for sending large packets. Groups A and B are defined for non-dedicated preambles, i.e. preambles for contention-based random access.

First the number of preambles for random access is indicated, and then, if applicable, the number of preambles for group A is indicated. From this information, the UE may infer the number of preambles in the group B when applicable.

It has been proposed in 3GPP meeting R2-140365 (RRC Signalling for PDSCH Frequency Allocation, Sony, 3GPP TSG RAN WG2 Meeting #85, 10^{th}-14^{th} Feb. 2014, Prague, Czech Republic) to reuse the existing preamble partitioning method to indicate the number of preambles for category 0 UEs by defining a new information element and locate those preambles as the last preambles in the set of non-dedicated preambles. The set of non-dedicated preambles and the preambles for category 0 UEs are overlapping which allows legacy UEs to use the non-dedicated preambles as before whereas category 0 UEs would only use a subset of the non-dedicated preambles.

It has also been discussed to use a fraction of dedicated preambles, i.e. contention-free random access preambles, for category 0 UEs where the network may further refrain from using those preambles for legacy UEs. The former approach is here referred to as soft partitioning whereas the latter one is termed as hard partitioning.

A problem with the soft and the hard partitioning approaches is that they exclude the possibility to make use of legacy preamble grouping for user equipment of category 0. If category 0 preambles are taken from dedicated preambles, the UE cannot belong to group A or B anymore because groups A and B are defined for non-dedicated preambles only, as mentioned above. Similarly, if the preambles for category 0 UEs are a subset of non-dedicated preambles, category 0 cannot make use of dedicated preambles. In addition, if the soft partitioning defines category 0 preambles in a fixed position e.g. as the last preambles of the set of non-dedicated preambles, it is difficult to allocate category 0 preambles such that they can also belong to either group A or B.

Embodiments herein provide a preamble partitioning area, that may be movable, i.e. a dynamic or re-configurable partitioning area, which may overlap both dedicated and non-dedicated preambles as well as group A and B depending on the configuration. A movable partitioning may be composed of pointers to the first and the last preamble instead of signaling the number of preambles.

As mentioned above embodiments herein enable a more flexible preamble partitioning for category 0 UEs because category 0 UEs may be allocated both dedicated and non-dedicated preambles.

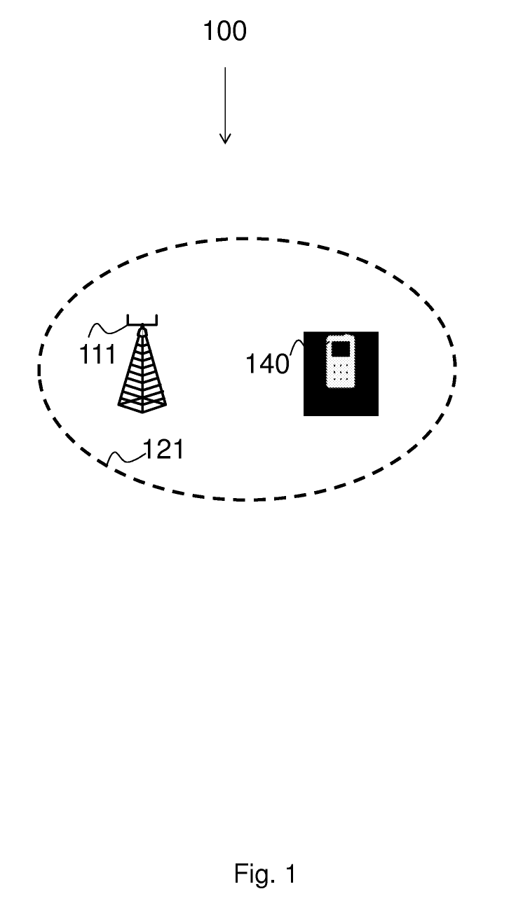

Embodiments herein may be implemented in one or more wireless communications networks whereof FIG. 1 depicts parts of a wireless communication network 100. The wireless communications network 100 may for example be LTE, UMTS, GSM, any 3GPP wireless communications network, or any cellular wireless communications network or system capable of handling UEs of more than one category or of different capabilities.

The wireless communications network 100 comprises a plurality of base stations and/or other network nodes. More specifically, the wireless communications network 100 comprises a network node 111.

The term “network node” may correspond to any type of radio network node or any network node, which communicates with at least a radio network node. For example, the network node 111 may be a base station, such as an eNB. The base station may also be referred to as a NodeB, an evolved Node B (eNB, eNode B), a base transceiver station (BTS), Access Point (AP) Base Station, Wi-Fi AP, base station router, or any other network unit capable of communicating with a user equipment within a cell served by the base station depending e.g. on the radio access technology and terminology used. The network node 111 may also be an RNC in an UMTS system.

The network node 111 serves a cell 121. A cell is a geographical area where radio coverage is provided by network node equipment such as Wi-Fi AP equipment, base station equipment at a base station site or at remote locations in Remote Radio Units (RRU). The network node 111 is an example of such network node equipment. The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying cells uniquely in the whole of a wireless communication network is also broadcasted in the cells.

Network nodes, such as base stations and Wi-Fi AP, communicate over the air or radio interface operating on radio frequencies with user equipment within range of the network nodes. The user equipment transmit data over the radio interface to network nodes, such base stations and Wi-Fi AP, in UL transmissions, and network nodes, such as Wi-Fi AP and base stations, transmit data over an air or radio interface to the user equipment in DL transmissions.

The network node 111 communicates with user equipments in the cell 121, such as a user equipment 140, also referred to as an UE or a wireless device.

In some embodiments the user equipment 140 is of a first category. The first category may have limited memory and/or processing capabilities and/or requirements compared with the least capable legacy UE category, such as category 1. The first category may be and/or comprise category 0. The user equipment 140 may be an MTC user equipment.

The user equipment 140 may further be e.g. a mobile terminal or a wireless terminal, a mobile phone, a computer such as e.g. a laptop, a Personal Digital Assistants (PDAs) or a tablet computer, sometimes referred to as a surf plate, with wireless capability, target device, device to device UE, MTC UE or UE capable of machine to machine communication, iPAD, mobile terminals, smart phone, Laptop Embedded Equipment (LEE), Laptop Mounted Equipment (LME), USB dongles etc. or any other radio network units capable to communicate over a radio link in a wireless communications network. Please note the term user equipment used in this document also covers other wireless devices such as Machine to machine (M2M) devices, even though they do not have any user.

In this section, the embodiments herein will be illustrated in more detail by a number of exemplary embodiments. The following embodiments will be described using LTE as an example and the network node 111 will be an LTE base station, i.e. an eNB. The first category is exemplified with category 0 below.

It should be noted that these embodiments are not mutually exclusive. Components from one embodiment may be tacitly assumed to be present in another embodiment and it will be obvious to a person skilled in the art how those components may be used in the other exemplary embodiments.

As mentioned above, before the user equipment 140 makes a random access, it reads system information to acquire information on what kind of preambles are available for transmission of a random access request. EUTRA system information includes the Information Element (IE) RACH-ConfigCommon that defines the sequence preambleInfo for that purpose. The preambleInfo provides information about the number of available preambles as well as possible grouping of the preambles if grouping is used. The IE RACH-ConfigCommon is thus used to specify the generic random access parameters.

Embodiments herein provide a non-critical extension to the above-mentioned IE RACH-ConfigCommon. The extension is termed as addtionalPreambleInfo in embodiments herein. The extension is composed of two enumerated lists to point out the first preamble where the preamble area starts and the last preamble where the preamble area ends.

The addtionalPreambleInfo may be implemented as described below. The example contains Abstract Syntax Notation one (ASN:1) coding of the information element syntax as well as descriptions of the protocol field semantics.

| | | |
|---|---|---|
| [[ | AddtionalPreambleInfo | SEQUENCE { |
| | firstRA-Preamble | ENUMERATED { |
| | | n1, n5, n9, n13,n17, |
| | | n21, n25, n29, n33, |
| | | n37, n41, n45, n49, |
| | | n53, n57, n61}, |
| | lastRA-Preamble | ENUMERATED { |
| | | n4, n8, n12, n16, n20, |
| | | n24, n28, n32, n36, |
| | | n40, n44, n48, n52, |
| | | n56, n60, n64} |

```
    }
]]
  addtionalPreambleInfo
```

A firstRA-Preamble field may be defined. The firstRA-Preamble field points to an index of the first preamble of the preamble area. Value n1 corresponds to a first preamble; n5 corresponds to a fifth preamble and so on.

EUTRAN may configure the firstRA-Preamble field to a lower value than a lastRA-Preamble field. In some embodiments the firstRA-Preamble field is used by category 0 UEs only.

The lastRA-Preamble field points to an index of the last preamble of the preamble area. Value n4 corresponds to a fourth preamble 4; n8 corresponds to an eighth preamble and so on.

EUTRAN may configure the lastRA-Preamble field to a higher value than the firstRA-Preamble field. In some embodiments the lastRA-Preamble field is used by category 0 UEs only.

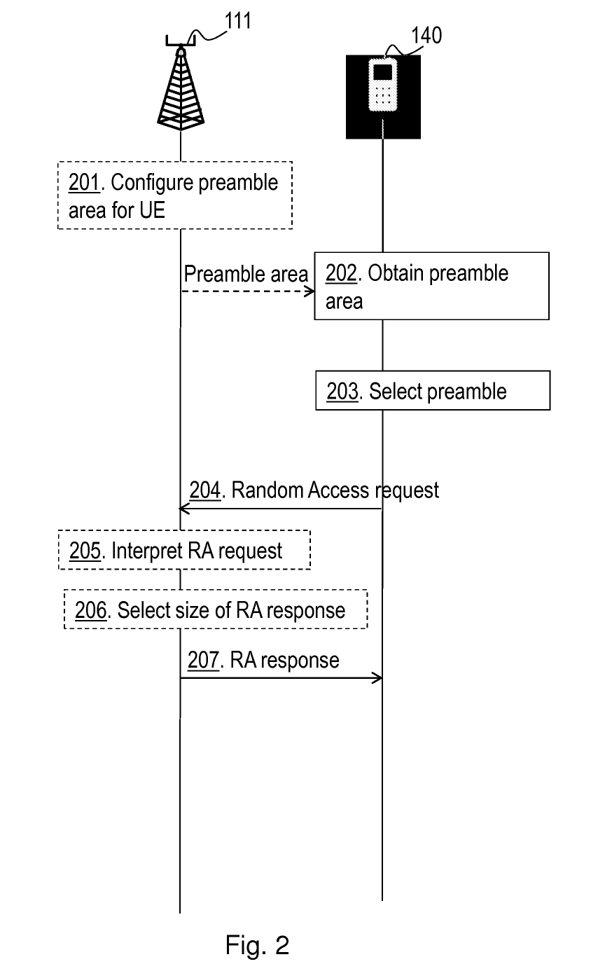

FIG. 2 is a combined signalling diagram and flow chart that describes actions that may take place to perform random access of the user equipment 140 to the network node 111 in the wireless communications network 100 according to embodiments herein.

Action 201

In this action the network node 111 configures a preamble area defined by a first random access preamble and a last random access preamble. The preamble area is to be used by the user equipment 140 when making a random access request towards the network node 111.

Further, the preamble area is overlapping with any one or more out of: preambles used for contention free random access and preambles used for contention-based random access.

In this way the preamble area may be configured with a high degree of flexibility, e.g. the preamble area may be movable. A movable preamble area means that the preamble area is not restricted to certain preambles, e.g. a group of preambles used for contention based random access.

When the preamble area is movable the network node 111 may dynamically configure specific preambles to specific categories of user equipment and/or specific user equipment, such as the user equipment 140. For example, in a first instant of time the network node 111 may configure a first preamble area for category 0 user equipment, while a second preamble area may be configured for category 1 user equipment. In a second instant of time the network node 111 may instead configure the first preamble area for category 1 user equipment.

In some embodiments two or more pointers define the respective first random access preamble and last random access preamble. That is, a first pointer may be used to define the first random access preamble and a second pointer may be used to define the last random access preamble. The use of pointers makes the method very flexible since it allows many combinations of preambles.

A configuring module 410 in the network node 111 may be configured to perform action 201.

Action 202

The user equipment 140 obtains information on the preamble area comprising one or more preambles available for transmission of the random access request from the user equipment 140. The preamble area is defined by the first random access preamble and the last random access preamble. The preamble area is overlapping with any one or more out of: preambles used for contention free random access and preambles used for contention-based random access.

The first random access preamble is configured to a lower value than the last random access preamble.

In some embodiments the network node 111 transmits system information comprising the preamble area to the user equipment 140, i.e. the user equipment 140 obtains the information on the preamble area from the network node 111.

In some other embodiments the user equipment 140 obtains the information on the preamble area from preconfigured information from the SIM card of the user equipment 140.

The user equipment 140 may obtain the information on the preamble area by computing the preamble area from specified default values upon absence of system information.

An obtaining module 610 in the user equipment 140 may be configured to perform action 202.

This action is related to action 301 and 501 below.

Action 203

When the user equipment 140 has obtained the information on the preamble area the user equipment 140 selects a preamble from the preamble area.

A selecting module 620 in the user equipment 140 may be configured to perform action 203.

This action is related to action 502 below.

Action 204

The user equipment 140 then transmits the random access request comprising the selected preamble to the network node 111.

A transmitting module 630 in the user equipment 140 may be configured to perform action 204.

This action is related to action 503 below.

Action 205

In some embodiments, the network node 111 interprets the received random access request as a request for random access of a user equipment of the first category, such as category 0.

This action may be performed by means such as an interpreting module 440 in the network node 111.

Action 206

The network node 111 may select a size of a random access response to the user equipment 140 based on the transmitted preamble that belong to the preamble area. In other words, if the user equipment 140 belongs to a category that is only capable of receiving random access responses below a certain size, i.e. with a certain size limitation, the network node 111 may limit the size of the random access response to the user equipment 140 based on the selected preamble that belongs to the preamble area. The size may be limited to a maximum bandwidth, e.g. 6 PRBs or a maximum transport block size, e.g. 1000 bits.

The selecting, or in other words the limiting, may be performed by means such as a limiting module 450 in the network node 111.

Action 207

The network node 111 transmits to the user equipment 140 the random access response. The size of the random access response is based on the preamble that belongs to the preamble area.

This action may be performed by means such as a transmitting module 420 in the network node 111.

This action is related to action 304 below.

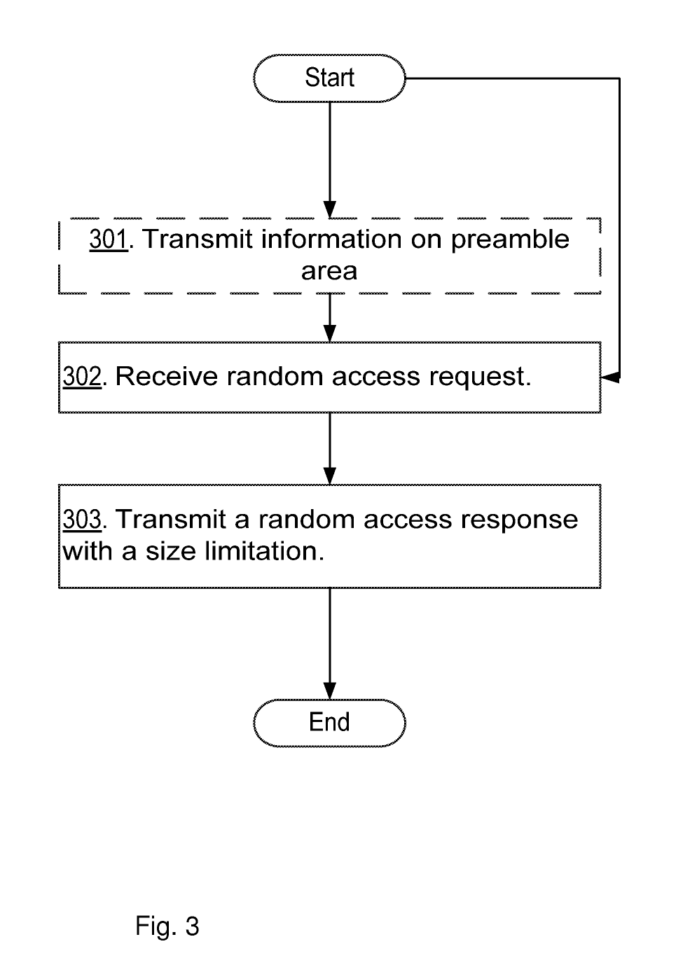

Embodiments of a method in the network node 111 for random access of the user equipment 140 to the network node 111 in the wireless communications network 100 will now be described with reference to a flowchart depicted in FIG. 3.

In some embodiments the user equipment 140 is of the first category. The first category may have limited memory and/or processing capabilities and/or requirements. The first category may be and/or comprise category 0. The user equipment 140 may be of the MTC type.

The method comprises the following actions, which actions may be taken in any suitable order.

Action 301

In some embodiments the network node 111 transmits to the user equipment 140 system information comprising the preamble area, which preamble area is to be used by the user equipment 140 for random access.

The transmitting module 420 in the network node 111 may be configured to perform action 301.

This action is related to action 202 above.

Action 302

The network node 111 receives from the user equipment 140 the random access request. As mentioned above in action 204, the random access request comprises the preamble that belongs to the preamble area. The preamble area comprises the one or more preambles available for transmission of random access requests from the user equipment 140.

As mentioned above the preamble area is defined by the first random access preamble and the last random access preamble.

Further, the preamble area is overlapping with any one or more out of: preambles used for contention free random access and preambles used for contention-based random access.

In this way, any user equipment, regardless of capability and category, is able to use many possible combinations of preambles and groups of preambles for their random access requests.

A receiving module 430 in the network node 111 may be configured to perform action 302.

This action is related to action 204 above.

Action 303

The network node 111 transmits to the user equipment 140 the random access response. The size of the random access response is based on the preamble that belongs to the preamble area.

Since the size of the random access response is based on the preamble that belongs to the preamble area the user equipment 140 is able to decode the random access response. Specifically, user equipment with low complexity, e.g. user equipment that are less capable than category 1, currently the least capable category, are able to decode the random access response without the need for a specific random access response for such user equipment.

The transmitting module 420in the network node 111 may be configured to perform action 303.

This action is related to action 206 above.

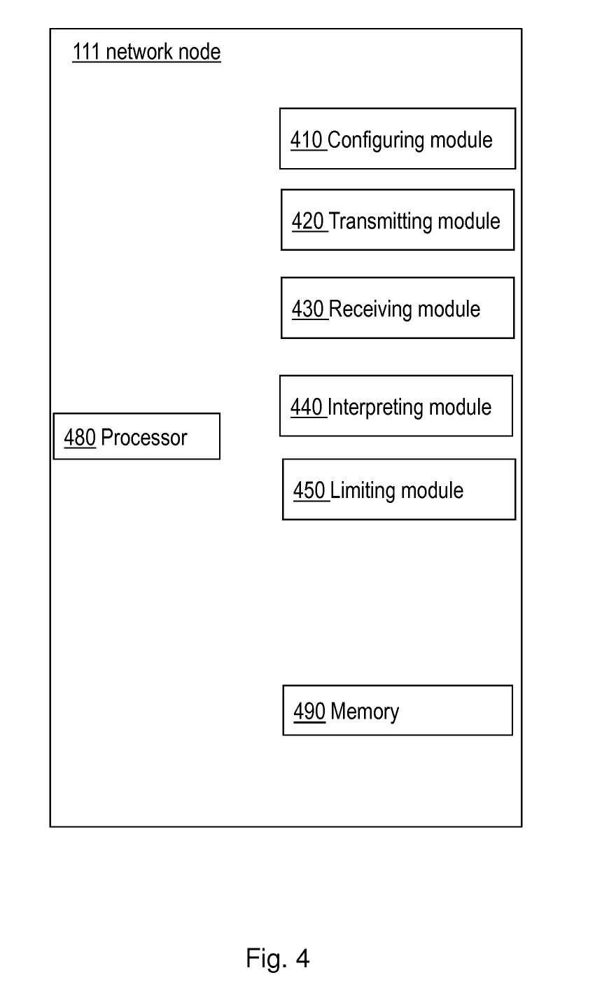

To perform the method actions for random access of the user equipment 140 to the network node 111 in the wireless communications network 100 described above in relation to FIG. 2 and FIG. 3, the network node 111, comprises the following arrangement depicted in FIG. 4.

As mentioned above, the user equipment 140 may be of the first category. In some embodiments, the first category comprises category 0. Further, the user equipment 140 may be of the MTC type.

The network node 111 is configured to, e.g. by means of the receiving module 430 configured to, receive from the user equipment 140 the random access request. The random access request comprises the preamble that belongs to the preamble area. The preamble area comprises the one or more preambles available for transmission of random access requests from the user equipment 140. The preamble area is defined by the first random access preamble and the last random access preamble. The preamble area is overlapping with any one or more out of: preambles used for contention free random access and preambles used for contention-based random access.

The preamble area may be movable.

In some embodiments the two or more pointers define the respective first random access preamble and last random access preamble.

The receiving module 430 may be implemented by a receiver in the network node 111.

The network node 111 is further configured to, e.g. by means of the transmitting module 420 configured to, transmit to the user equipment 140 the random access response. The random access response has a size based on the preamble that belongs to the preamble area.

The transmitting module 420 may be implemented by a transmitter in the network node 111.

The network node 111 may further be configured to, e.g. by means of the transmitting module 420 configured to, transmit to the user equipment 140 system information comprising the preamble area.

The network node 111 may further be configured to, e.g. by means of a memory 490 configured to, store for example preambles, pointers, indications, messages, categories of user equipment and capabilities of user equipment, information, data, configurations, schedulings, and applications etc to perform the methods herein when being executed in the network node 111. The memory 490 comprises one or more memory units.

The embodiments herein to perform handover preparation of the user equipment 140 in the wireless communications network 100 may be implemented through one or more processors, such as the processor 480 in the network node 111 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the network node 111. One such carrier may be in the form of a CD ROM disc. It is however feasible with other data carriers such as a memory stick. The computer program code may furthermore be provided as pure program code on a server and downloaded to the network node 111.

Thus, the methods according to the embodiments described herein for the network node 111 may be implemented by means of a computer program product, comprising instructions, i.e., software code portions, which, when executed on at least one processor, cause the at least one processor to carry out the actions described herein, as performed by the network node 111. The computer program product may be stored on a computer-readable storage medium. The computer-readable storage medium, having stored there on the computer program, may comprise the instructions which, when executed on at least one processor, cause the at least one processor to carry out the actions described herein, as performed by the network node 111. In some embodiments, the computer-readable storage medium may be a non-transitory computer-readable storage medium.

Those skilled in the art will also appreciate that the configuring module 410, the transmitting module 420, the receiving module 430, the interpreting module 440 and the limiting module 450 described above may refer to a combination of analogue and digital circuits, and/or one or more processors configured with software and/or firmware, e.g. stored in a memory, that when executed by the one or more processors such as the processor 480 perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

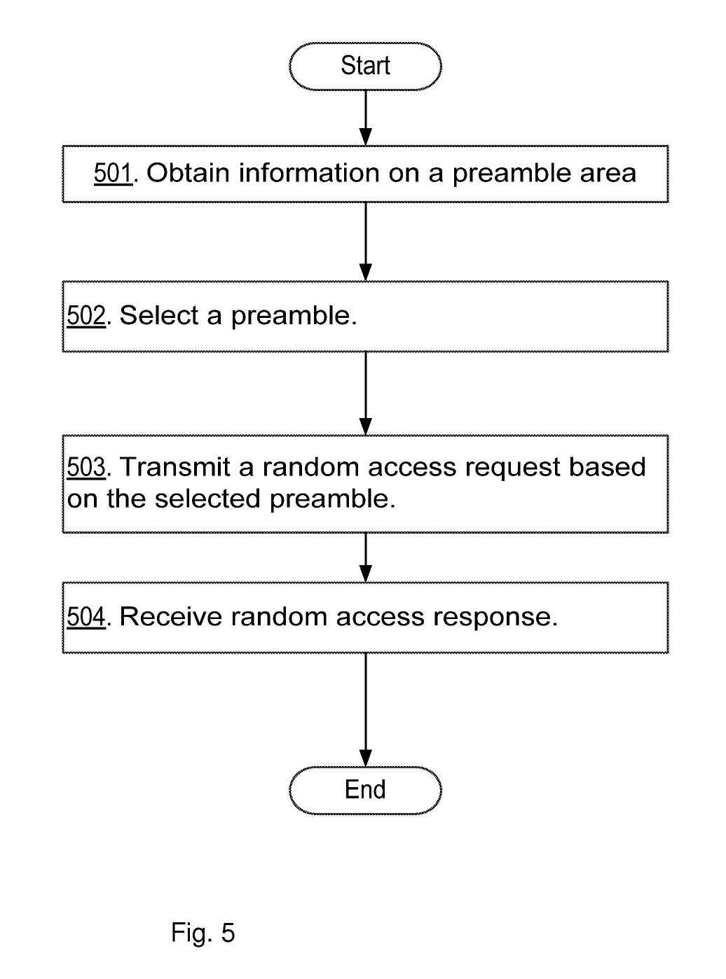

Embodiments of a method in the user equipment 140 for random access of the user equipment 140 to the network node 111 in the wireless communications network 100, will now be described with reference to a flowchart depicted in FIG. 5.

The behaviour of the user equipment 140 may be specified in the Medium Access Control (MAC) protocol.

As mentioned above, the user equipment 140 may be of the first category. In some embodiments, the first category comprises category 0. Further, the user equipment 140 may be of the MTC type.

The method comprises the following actions, which actions may be taken in any suitable order.

Action 501

The user equipment 140 obtains information on the preamble area comprising the one or more preambles available for transmission of the random access request from the user equipment 140. The preamble area is defined by the first random access preamble and the last random access preamble. The preamble area is overlapping with any one or more out of: preambles used for contention free random access and preambles used for contention-based random access.

In this way user equipment of the first category, e.g. category 0, may be allocated and is able to use both preambles used for contention free random access and preambles used for contention-based random access as well as preambles from group A and B.

The first random access preamble is configured to a lower value than the last random access preamble.

The preamble area may be movable. As mentioned above, a movable preamble area means that the preamble area is not restricted to certain preambles, e.g. a group of preambles used for contention based random access.

In some embodiments two or more pointers define the respective first random access preamble and last random access preamble.

The user equipment 140 may obtain the information on the preamble area by receiving system information from the network node 111. The system information comprises the information on the preamble area.

In some embodiments the user equipment 140 obtains the information on the preamble area from preconfigured information from the SIM card of the user equipment 140.

The user equipment 140 may obtain the information on the preamble area by computing the preamble area from specified default values upon absence of system information. The computing may be performed by means such as a computing module 640 in user equipment 140.

The obtaining module 610 in the user equipment 140 may be configured to perform action 501.

This action is related to action 202 above.

Action 502

When the user equipment 140 has obtained the information on the preamble area the user equipment 140 selects the preamble from the preamble area. The selected preamble is to be used for the random access request to the network node 111 described below. When the preamble is selected from the preamble area defined above there is a high degree of flexibility for the selection of the preamble. For example, user equipment of any category may make use of legacy preamble grouping.

The selecting module 620 in the user equipment 140 may be configured to perform action 502.

This action is related to action 203 above.

Action 503

The user equipment 140 then transmits the random access request to the network node 111. The random access request comprises the selected preamble that belongs to the preamble area, i.e. between the first random access preamble and the last random access preamble.

While the preamble area as defined above enables flexibility for different categories of user equipment, the transmitted preamble, selected from the preamble area, also allows the network node 111 to interpret the received random access request as a request for random access of a user equipment of a particular category, such as the first category, and thus select or limit the size of the random access response to the user equipment 140 such that the size is suitable for the particular category of the user equipment 140.

The transmitting module 630 in the user equipment 140 may be configured to perform action 503.

This action is related to action 204 above.

Action 504

The user equipment 140 receives the random access response. The size of the random access response is based on the selected preamble that belongs to the preamble area.

A receiving module 650 in the user equipment 140 may be configured to perform action 504.

This action is related to action 207 above.

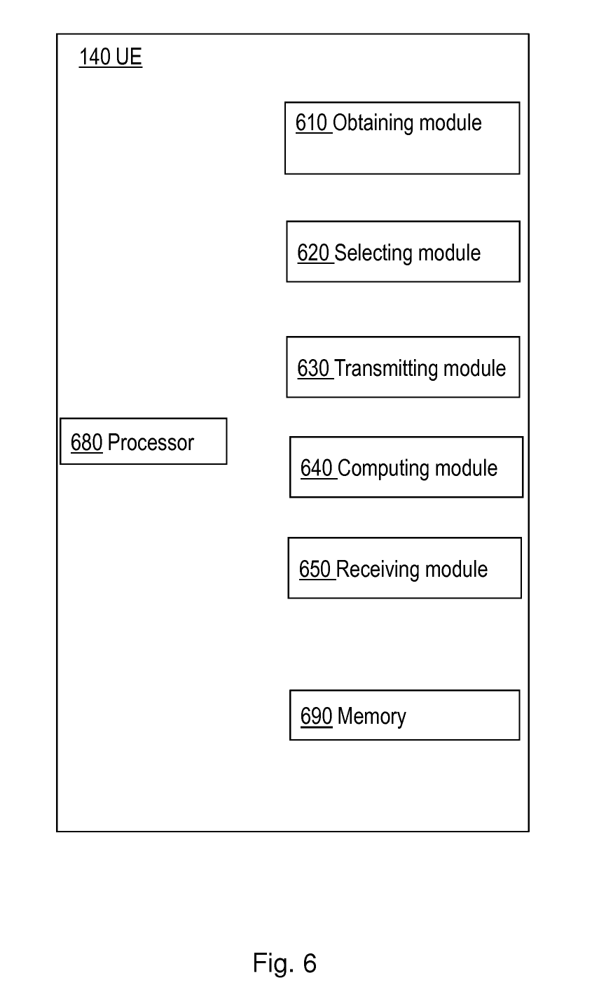

To perform the method actions for random access of the user equipment 140 to the network node 111 in the wireless communications network 100 described above in relation to FIG. 5, the user equipment 140 comprises the following arrangement depicted in FIG. 6.

As mentioned above, the user equipment 140 may be of the first category. In some embodiments, the first category comprises category 0. Further, the user equipment 140 may be of the MTC type.

The user equipment 140 is configured to, e.g. by means of the obtaining module 610 configured to, obtain information on the preamble area comprising the one or more preambles available for transmission of the random access request from the user equipment 140. The preamble area is defined by the first random access preamble and the last random access preamble. The preamble area is overlapping with the any one or more out of: preambles used for contention free random access and preambles used for contention-based random access.

In some embodiments the user equipment 140 is configured to obtain the information on the preamble area by receiving system information from the network node 111. The system information comprises the information on the preamble area.

The preamble area may be movable.

In some embodiments the two or more pointers define the respective first random access preamble and last random access preamble.

The obtaining module 610 may be implemented by a receiver in the user equipment 140.

The user equipment 140 is further configured to, e.g. by means of the selecting module 620 configured to, select the preamble from the preamble area.

The selecting module 620 may be implemented by a processor 680 in the user equipment 140.

The user equipment 140 is further configured to, e.g. by means of the transmitting module 630 configured to, transmit the random access request to the network node 111 based on the selected preamble that belong to the preamble area.

The transmitting module 630 may be implemented by a transmitter in the user equipment 140.

The user equipment 140 is further configured to, e.g. by means of the receiving module 650 configured to, receive the random access response, which random access response has a size based on the selected preamble that belong to the preamble area.

The receiving module 650 may be implemented by a receiver in the user equipment 140.

The user equipment 140 may further be configured to, e.g. by means of a memory 690 configured to, store for example preambles, pointers, indications, messages, categories of user equipment and capabilities of user equipment, information, data, configurations, schedulings, and applications etc. to perform the methods herein when being executed in user equipment 140. The memory 690 comprises one or more memory units.

The embodiments herein to perform random access of the user equipment 140 to the network node 111 in the wireless communications network 100 may be implemented through one or more processors, such as the processor 680 in user equipment 140 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the user equipment 140. One such carrier may be in the form of a CD ROM disc. It is however feasible with other data carriers such as a memory stick. The computer program code may furthermore be provided as pure program code on a server and downloaded to the user equipment 140.

Thus, the methods according to the embodiments described herein for the user equipment 140 may be implemented by means of a computer program product, comprising instructions, i.e., software code portions, which, when executed on at least one processor, cause the at least one processor to carry out the actions described herein, as performed by the user equipment 140. The computer program product may be stored on a computer-readable storage medium. The computer-readable storage medium, having stored there on the computer program, may comprise the instructions which, when executed on at least one processor, cause the at least one processor to carry out the actions described herein, as performed by the user equipment 140. In some embodiments, the computer-readable storage medium may be a non-transitory computer-readable storage medium.

Those skilled in the art will also appreciate that the obtaining module 610, the selecting module 620, the transmitting module 630, the computing module 640 and the receiving module 650 described above may refer to a combination of analogue and digital circuits, and/or one or more processors configured with software and/or firmware, e.g. stored in a memory, that when executed by the one or more processors such as the processor 680 perform as described above. One or more of these processors, as well as the other digital hardware, may be included in a single ASIC, or several processors and various digital hardware may be distributed among several separate components, whether individually packaged or assembled into a SoC.

The following embodiment will be described using LTE as an example and the network node 111 will be an LTE base station, i.e. eNB. The first category is exemplified with category 0 below.

One possible embodiment is exemplified below based on procedures from the EUTRA MAC protocol. The procedure from the EUTRA MAC protocol is described in the 3GPP TS 36.321 sub clause 5.1.1. The following parts may be needed for the procedure initialization.

The Random Access procedure described is initiated by a Physical Downlink Control Channel (PDCCH) order or by the MAC sublayer itself. Random Access procedure on a Secondary Cell (SCell) shall only be initiated by a PDCCH order. If the user equipment 140 receives a PDCCH transmission consistent with a PDCCH order masked with its C-RNTI, and for a specific Serving Cell, the user equipment 140 shall initiate a Random Access procedure on this Serving Cell. For Random Access on the Primary Cell (PCell) a PDCCH order or RRC configuration message optionally indicate the ra-PreambleIndex and the ra-Physical Random Access Channel (PRACH)-MaskIndex; and for Random Access on an SCell, the PDCCH order indicates the ra-PreambleIndex with a value different from 000000 and the ra-PRACH-MaskIndex. For the pTAG preamble transmission on PRACH and reception of a PDCCH order are only supported for PCell.

Before the procedure may be initiated, the following information for related Serving Cell may be assumed to be available:

the available set of PRACH resources for the transmission of the Random Access Preamble, prach-ConfigIndex.

the groups of Random Access Preambles and the set of available Random Access Preambles in each group, valid for PCell only:

The preambles that are contained in Random Access Preambles group A and Random Access Preambles group B are calculated from the parameters numberOfRA-Preambles and size OfRA-PreamblesGroupA:

The set of preambles that are intended for category 0 UEs are obtained from the firstRA-Preamble and lastRA-Preamble

If sizeOfRA-PreamblesGroupA is equal to numberOfRA-Preambles then there is no Random Access Preambles group B. The preambles in Random Access Preamble group A are the preambles 0 to sizeOfRA-PreamblesGroupA—1 and, if it exists, the preambles in Random Access Preamble group B are the preambles sizeOfRA-PreamblesGroupA to numberOfRA-Preambles—1 from the set of 64 preambles.

if Random Access Preambles group B exists, the thresholds, messagePowerOffsetGroupB and messageSizeGroupA, the configured UE transmitted power of the Serving Cell performing the Random Access Procedure, PCMAX, c, and the offset between the preamble and Msg3, deltaPreambleMsg3, that are required for selecting one of the two groups of Random Access Preambles, valid for PCell only.

the RA response window size ra-ResponseWindowSize.

the power-ramping factor powerRampingStep.

the maximum number of preamble transmission preambleTransMax.

the initial preamble power preambleInitialReceivedTargetPower.

the preamble format based offset DELTA_PREAMBLE (see subclause 7.6).

the maximum number of Msg3 HARQ transmissions maxHARQ-Msg3Tx (PCell only).

the Contention Resolution Timer mac-ContentionResolutionTimer (PCell only).

Similarly the UE behaviour capture the fact that it may only use the subset of the preamble that belongs to the preamble area defined above. An embodiment of the behaviour is based on EUTRA MAC protocol subclause 5.1.2 in the following manner.

The Random Access Resource selection procedure may be performed as follows:

If ra-PreambleIndex (Random Access Preamble) and ra-PRACH-MaskIndex (PRACH Mask Index) have been explicitly signalled and ra-PreambleIndex is not 000000:

the Random Access Preamble and the PRACH Mask Index are those explicitly signalled.

else the Random Access Preamble shall be selected by the UE as follows:

If Msg3 has not yet been transmitted, the UE shall:

if Random Access Preambles group B exists and if the potential message size (data available for transmission plus MAC header and, where required, MAC control elements) is greater than messageSizeGroupA and if the pathloss is less than PCMAX,c (of the Serving Cell performing the Random Access Procedure)—preambleInitialReceivedTargetPower—deltaPreambleMsg3—messagePowerOffsetGroupB, then:

select the Random Access Preambles group B;

else:

select the Random Access Preambles group A.

else, if Msg3 is being retransmitted, the UE shall:

select the same group of Random Access Preambles as was used for the preamble transmission attempt corresponding to the first transmission of Msg3.

randomly select a Random Access Preamble within the selected group. Category 0 UE shall select the Random Access Preamble such that it belongs to the subset of category 0 UE preamble as defined by firstRA-Preamble and lastRA-Preamble. The random function shall be such that each of the allowed selections may be chosen with equal probability;

set PRACH Mask Index to 0.

determine the next available subframe containing PRACH permitted by the restrictions given by the prach-ConfigIndex, the PRACH Mask Index (see subclause 7.3) and physical layer timing requirements, a UE may take into account the possible occurrence of measurement gaps when determining the next available PRACH subframe;

if the transmission mode is TDD and the PRACH Mask Index is equal to zero:

if ra-PreambleIndex was explicitly signalled and it was not 000000 (i.e., not selected by MAC):

randomly select, with equal probability, one PRACH from the PRACHs available in the determined subframe.

else:

randomly select, with equal probability, one PRACH from the PRACHs available in the determined subframe and the next two consecutive subframes.

else:

determine a PRACH within the determined subframe in accordance with the requirements of the PRACH Mask Index.

proceed to the transmission of the Random Access Preamble (see subclause 5.1.3).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope, which is defined by the appending claims.

Note that although terminology from 3GPP LTE/SAE has been used in this disclosure to exemplify the embodiments herein, this should not be seen as limiting the scope of the embodiments herein to only the aforementioned system. Other wireless systems may also benefit from exploiting the ideas covered within this disclosure.

Also note that terminology such as a first network node and a second network node should be considered to be non-limiting and does in particular not imply a certain hierarchical relation between the two.

1-28. (canceled)

29. A method in a network node for random access of a user equipment to the network node in a wireless communications network, the method comprising:
receiving from the user equipment a random access request which random access request comprises a preamble that belongs to a preamble area, which preamble area comprises one or more preambles available for transmission of random access requests from the user equipment, and which preamble area is defined by a first random access preamble and a last random access preamble, and which preamble area is overlapping with any one or more of: preambles used for contention free random access and preambles used for contention-based random access; and
transmitting to the user equipment a random access response, which random access response has a size based on the preamble that belongs to the preamble area.

30. The method according to claim 29, further comprising transmitting to the user equipment system information comprising the preamble area.

31. The method according to claim 29, wherein the preamble area is movable.

32. The method according to claim 29, wherein two or more pointers define the respective first random access preamble and last random access preamble.

33. The method according to claim 29, wherein the user equipment is of a first category.

34. The method according to claim 33, wherein the first category comprises category 0.

35. The method according to claim 29, wherein the user equipment is of a Machine Type Communication (MTC) type.

36. A network node for random access of a user equipment to the network node in a wireless communications network, the network node is configured to:
receive from the user equipment a random access request which random access request comprises a preamble that belongs to a preamble area, which preamble area comprises one or more preambles available for transmission of random access requests from the user equipment, and which preamble area is defined by a first random access preamble and a last random access preamble, and which preamble area is overlapping with any one or more of: preambles used for contention free random access and preambles used for contention-based random access; and
transmit to the user equipment a random access response, which random access response has a sizebased on the preamble that belongs to the preamble area.

37. The network node according to claim 36, further configured to transmit to the user equipment system information comprising the preamble area.

38. The network node according to claim 36, wherein the preamble area is movable.

39. The network node according to claim 36, wherein two or more pointers define the respective first random access preamble and last random access preamble.

40. The network node according to claim 36, wherein the user equipment is of a first category.

41. The network node according to claim 40, wherein the first category comprises category 0.

42. The network node according to claim 40, wherein the user equipment is of a Machine Type Communication (MTC) type.

43. A method in a user equipment for random access of the user equipment to a network node in a wireless communications network, the method comprising:
obtaining information on a preamble area comprising one or more preambles available for transmission of a random access request from the user equipment, which preamble area is defined by a first random access preamble and a last random access preamble, and which preamble area is overlapping with any one or more of: preambles used for contention free random access and preambles used for contention-based random access;
selecting a preamble that belongs to the preamble area;
transmitting a random access request to the network node, which random access response comprises the selected preamble that belongs to the preamble area; and
receiving a random access response, which random access response has a size based on the selected preamble that belongs to the preamble area.

44. The method according to claim 43, wherein the obtaining the information on the preamble area comprises receiving system information from the network node, which system information comprises the information on the preamble area.

45. The method according to claim 44, wherein the preamble area is movable.

46. The method according to claim 44, wherein two or more pointers define the respective first random access preamble and last random access preamble.

47. The method according to claim 44, wherein the user equipment is of a first category.

48. The method according to claim 47, wherein the first category comprises category 0.

49. The method according to claim 44, wherein the user equipment is of a Machine Type Communication (MTC) type.

50. A user equipment for random access of the user equipment to a network node in a wireless communications network, the user equipment is configured to:
obtain information on a preamble area comprising one or more preambles available for transmission of a random access request from the user equipment, which preamble area is defined by a first random access preamble and a last random access preamble, and which preamble area is overlapping with any one or more out of: preambles used for contention free random access and preambles used for contention-based random access;
select a preamble that belongs to the preamble area;
transmit a random access request to the network node comprising the selected preamble that belongs to the preamble area; and
receive a random access response, which random access response has a size based on the selected preamble that belongs to the preamble area.

51. The user equipment according to claim 50, further configured to obtain the information on the preamble area by receiving system information from the network node, which system information comprises the information on the preamble area.

52. The user equipment according to claim 50, wherein the preamble area is movable.

53. The user equipment according to claim 50, wherein two or more pointers define the respective first random access preamble and last random access preamble.

54. The user equipment according to claim 50, wherein the user equipment is of a first category.

55. The user equipment according to claim 54, wherein the first category comprises category 0.

56. The user equipment according to claim 50, wherein the user equipment is of a Machine Type Communication (MTC) type.
